(19) United States
(12) Patent Application Publication
(10) Pub. No.: US 2007/0297522 A1
(43) Pub. Date: Dec. 27, 2007

(54) Method for Signal Processing and a Signal Processor in an Ofdm System

(75) Inventors: Constant Paul Marie Jozef Baggen, Eindhoven (NL); Sri Andari Husen, Eindhoven (NL); Maurice Leonardus Anna Stassen, Eindhoven (NL); Hoi Yip Tsang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,595

(22) PCT Filed: May 24, 2005
(86) PCT No.: PCT/IB05/51685

§ 371 Date: Nov. 27, 2006

(30) Foreign Application Priority Data
May 28, 2004 (EP) 04102374.8

(51) Int. Cl. H04L 27/28

(52) U.S. Cl. 375/260; 375/E01.033

(57) ABSTRACT

A method of signal processing for a receiver for OFDM encoded digital signals, for counteracting inter-carrier interference (ICI) caused by Doppler broadening. The OFDM encoded digital signals are transmitted as sub-carriers in several channels, which form OFDM blocks. The method comprises estimation of a channel transfer function (Ĥ₁) by a channel estimation scheme in each sub-carrier and estimation of data (â₁) by a data estimation scheme from said channel transfer function (Ĥ₁) and a received signal (y₀). Then, a derivative (Hⱼ′) of said channel transfer function in each sub-carrier is estimated by a temporal filtering; and the inter-carrier interference (ICI) is removed from said received signal by using the estimated data (â₁) and the estimated derivative (Hⱼ′) of the channel transfer function in order to obtain a cleaned received signal (y₁).

The present invention relates to a method of signal processing for a receiver for encoded digital signals in a wireless communication system and a corresponding signal processor.

The invention also relates to a receiver that receives the OFDM encoded signals, and to a mobile device comprising such receiver. The invention also relates to a telecommunication system comprising a mobile device. The method may be used for mitigating inter-carrier interference (ICI), for example caused by Doppler broadening in, for example, a terrestrial video broadcasting system DVB-T using OFDM technique.

A mobile device can for example be a portable television, a mobile phone, a personal digital assistant (PDA) or a portable computer, such as a laptop or any combination thereof.

In wireless systems for the transmission of digital information, such as voice and video signals, orthogonal frequency division multiplexing technique (OFDM) has been widely used. OFDM may be used to cope with frequency-selective fading radio channels. Interleaving of data may be used for efficient data recovery and use of data error correction schemes.

OFDM is today used in for example the Digital Audio Broadcasting (DAB) system Eureka 147 and the Terrestrial Digital Video Broadcasting system (DVB-T). DVB-T supports 5-30 Mbps net bit rate, depending on modulation and coding mode, over 8 MHz bandwidth. For the 8K mode, 6817 sub-carriers (of a total of 8192) are used with a sub-carrier spacing of 1116 Hz. OFDM symbol useful time duration is 896 μs and OFDM guard interval is ¼, ⅛, 1/16 or 1/32 of the time duration.

However, in a mobile environment, such as a car or a train, the channel transfer function as perceived by the receiver varies as a function of time. Such variation of the transfer function within an OFDM symbol may result in inter-carrier interference, ICI, between the OFDM sub-carriers, such as a Doppler broadening of the received signal. The inter-carrier interference increases with increasing vehicle speed and makes reliable detection above a critical speed impossible without countermeasures.

A signal processing method is previously known from WO 02/067525, WO 02/067526 and WO 02/067527, in which a data signal a as well as a channel transfer function H and the time derivative thereof H′ of an OFDM symbol are calculated for a specific OFDM symbol under consideration.

Moreover, U.S. Pat No. 6,654,429 discloses a method for pilot-aided channel estimation, wherein pilot symbols are inserted into each data packet at known positions so as to occupy predetermined positions in the time-frequency space. The received signal is subject to a two-dimensional inverse Fourier transform, two-dimensional filtering and a two-dimensional Fourier transform to recover the pilot symbols so as to estimate the channel transfer function.

An object of the present invention is to provide a method for signal processing which is less complex.

Another object of the invention is to provide a method for signal processing in which the time correlation of the channel transfer function H is used.

A further object of the invention is to provide a method of signal processing for an OFDM receiver in which inter-carrier interference ICI is mitigated.

These and other objects are met by a method for processing for OFDM encoded digital signals. The OFDM encoded digital signals are transmitted as sub-carriers in several frequency channels. A channel transfer function (Ĥ₁) is estimated by a channel estimation scheme in each sub-carrier followed by a data (a₁) estimation by a data estimation scheme from said channel transfer function (Ĥ₁) and a signal (y₀). Furthermore, a derivative (Hⱼ′) of said channel transfer function in a subset of the sub-carriers is estimated by a temporal filtering. Inter-carrier interference (ICI) is removed from said signal by using said estimated data (â₁) and said estimated derivative (Hⱼ′) of said channel transfer function in order to obtain a cleaned received signal (y₁).

The temporal filtering may be performed in virtual pilot channels for obtaining said derivative H_{I}′ for said pilot channels I, followed by spectral interpolation from said obtained derivative H_{I}′ for computing the derivative Hⱼ′ for remaining channels within an OFDM symbol. The virtual pilot channels may be a subset of all channels, for example spaced between 3 and 12 channels. Hence, it is possible to interpolate from the virtual pilot channels to the intermediate channels with a sufficient accuracy.

The temporal and spectral filtering may be performed by using a finite impulse transfer function (FIR) filter having pre-computed filter coefficients. Thus, the signal processing becomes less complex.

Estimates of said channel transfer function H from at least one other OFDM symbol may be used. This other OFDM symbol may be a past or a future OFDM symbol.

The inter-carrier interference (ICI) can be removed by using an initial estimation of said derivative H′ of said channel transfer function and an initial soft estimation of data. A further estimation of said channel transfer function H may be made after removal of said inter-carrier interference (ICI) in at least said virtual pilot channels, whereby a more accurate data estimation may be obtained.

The inter-carrier interference (ICI) may be removed by an iteration of data estimation steps and removal steps.

Another aspect of the invention comprises a signal processor for performing the method steps indicated above and the use of temporal Wiener filtering followed by spectral Wiener filtering according to the above-mentioned method steps for mitigating inter-carrier interference.

Further objects, features and advantages of the invention will become evident from a reading of the following description of an exemplifying embodiment of the invention with reference to the appended drawings, in which:

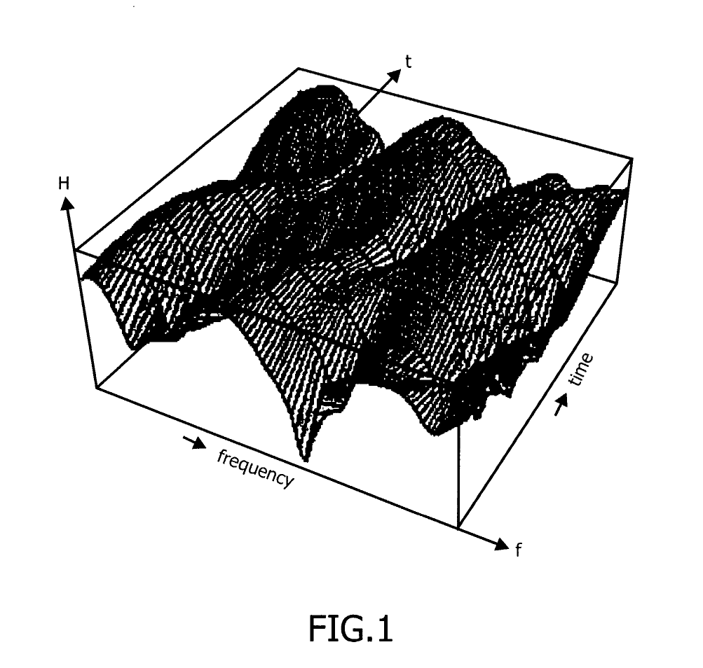

FIG. 1 is a graph showing the channel transfer function as a function of frequency and time;

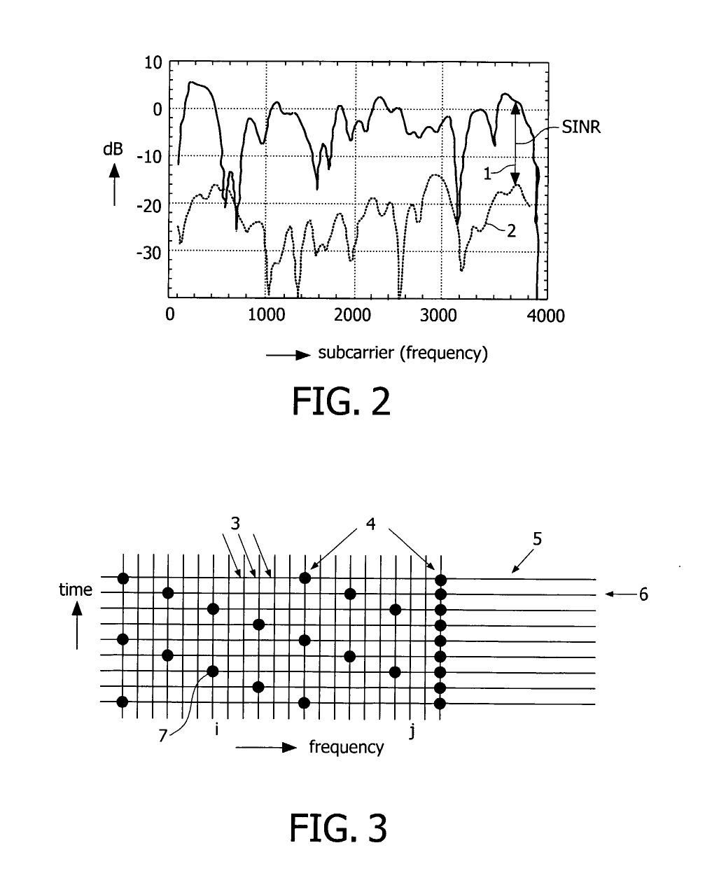

FIG. 2 is a diagram showing the wanted signal as a function of (sub-carrier) frequency;

FIG. 3 is a schematic diagram of OFDM symbols; and

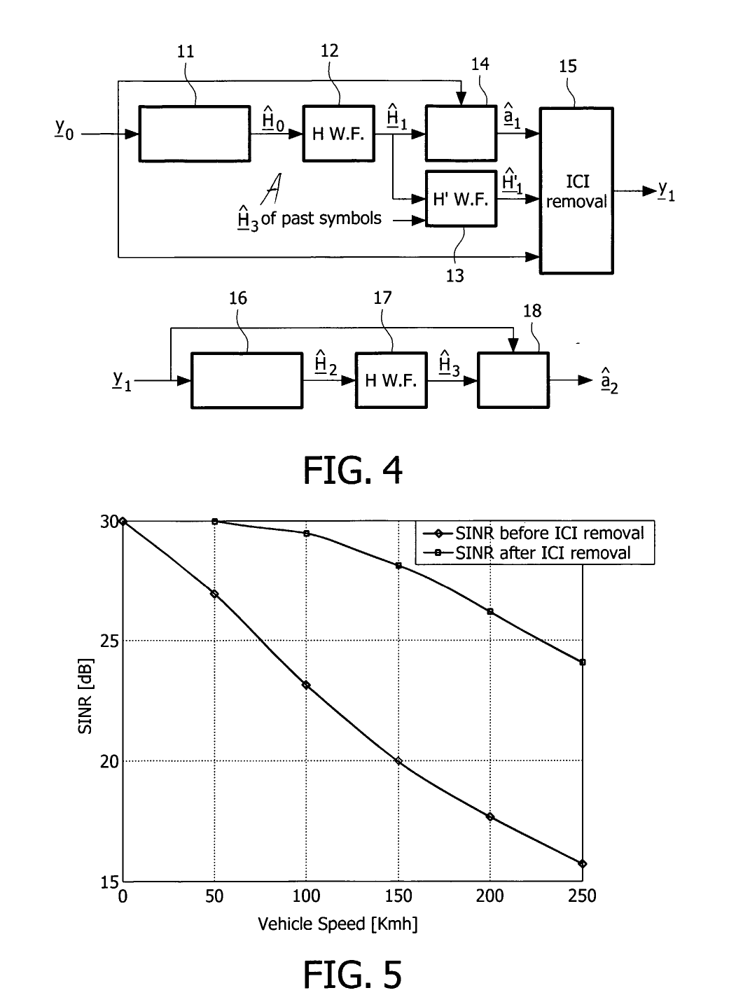

FIG. 4 is a flow diagram of an embodiment of the invention.

FIG. 5 is a diagram showing SINR before and after ICI removal for various speeds.

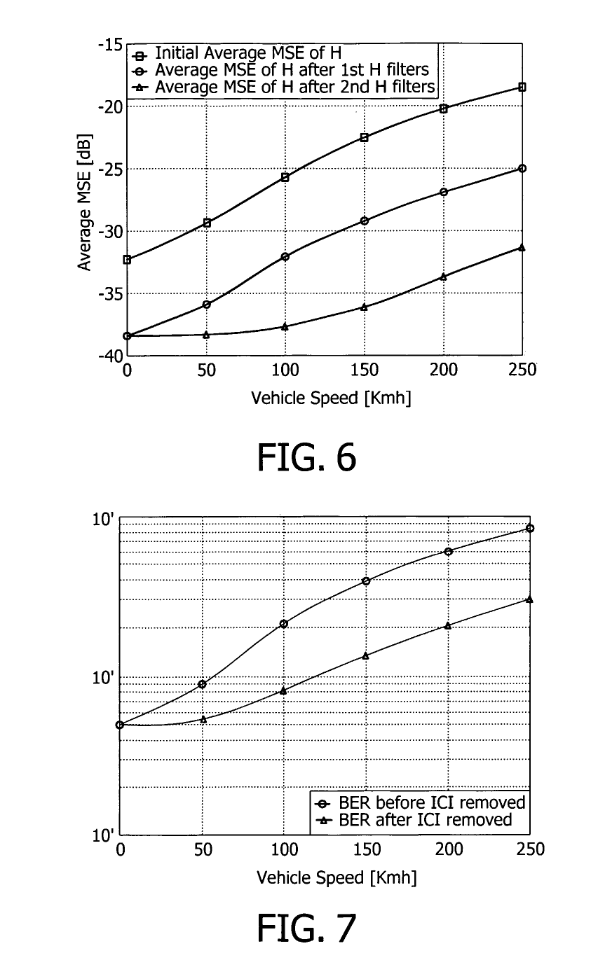

FIG. 6 is a diagram showing the average MSA of H for various speeds.

FIG. 7 is a diagram showing the Bit Error Rate, BER, before and after ICI removal for various speeds.

FIG. 1 is a graph showing variation of the sub-carrier channel transfer function H(ƒ) as perceived by the receiver as a function of frequency and time in a mobile environment. The variation of H(ƒ) within an OFDM symbol results in inter-carrier interference, ICI, between the OFDM sub-carriers, so-called Doppler broadening of the received signal.

FIG. 2 shows the variation of the wanted signal, as indicated by the upper solid line 1, over frequency. The sum of ICI and noise is indicated by a broken line 2. The difference between the curves is the signal-interference-noise ratio SINR. However, ICI increases with increasing vehicle speed, which makes reliable detection above a critical speed impossible without countermeasures.

According to the invention, it is observed that for all reasonable vehicle speeds and sub-carrier frequencies, the channel transfer function H for a given frequency varies almost linearly as a function of time over the duration of one OFDM symbol. In this case, it can be shown that the received signal y can be written as:
y≈(diag {H+Ξ·diag {H′})·a+n

wanted ICI noise

signal

where:

H is the complex transfer function of the channels

H′ is the temporal derivative of H

Ξ is the ICI spreading matrix

a is the transmitted data vector

n is a complex circular white Gaussian noise vector

The present invention is based on the finding that this equation can be used as a basis for a signal processing method, that uses the temporal as well as spectral correlation of H(ƒ) for obtaining estimates of H and H′ in each channel of each OFDM symbol. The method may use Wiener filters both in the frequency domain and the time domain for obtaining reliable estimates of H and H′, minimum MSE (mean square error) Wiener data estimators, and use of successive or iterative data estimation, ICI cancellation and H estimation. The result is a signal processing method which may be used for effective DVB-T reception in the presence of Doppler broadening of low to moderate complexity.

A DVB-T signal is characterized by a temporal concatenation of OFDM symbols, where each OFDM symbol 6 contains data carriers 3, pilot carriers 4 and empty carriers 5 as schematically shown in FIG. 3.

In a given OFDM symbol, a pilot 7 at sub-carrier i having a known transmitted value allows for the estimation of H₁ in that OFDM symbol.

Using the spectral correlation of H(ƒ) which depends on the delay spread of the channel, and the SINR characteristics, a Wiener filter can be designed which operates in the frequency domain that gives minimum mean square error (MMSE) estimates of Hⱼ in all channels of that given OFDM symbol. This Wiener filter is called a spectral Wiener filter.

Another Wiener filter is designed which uses the temporal correlation of Hⱼ in each channel, which depends on the Doppler frequency distribution of multipaths, and the SINR characteristics. This temporal Wiener filter gives a MMSE estimate of the time derivative H′ⱼ and Hⱼ in a given OFDM symbol.

The above-mentioned filters are designed for tracking and predicting Hⱼ and H′ⱼ in a given OFDM symbol.

The temporal Wiener filters may operate in a pre-selected set of channels I, called “virtual pilot channels” and the spectral Wiener filters provide estimates of H_{I} for each OFDM symbol. Such virtual pilot channels may be spaced between 3 and 12 channels.

In the virtual pilot channels, H′ᵢ for a given OFDM symbol is computed from the obtained Hᵢ using the corresponding temporal Wiener filter. Thence, the MMSE estimates of H′ⱼ and Hⱼ in all sub-carriers of each OFDM symbol are computed from the results in the virtual pilot channels using a spectral Wiener filter.

A data estimation part of the algorithm is based on an initial estimate of the unknown data in the data carriers using the received signal and the computed Hⱼ in each channel. Then, the estimated ICI is subtracted using H′ⱼ, the initial data estimate and the pilots, in relevant sub-carriers to obtain cleaned data carriers. Finally, re-estimation of the unknown data is made in the cleaned data carriers.

Since an accurate estimation of H turns out to be very important for data estimation, the channel transfer function H may also be recomputed or filtered from the cleaned pilot carriers.

Thus, the basic idea of the invention is the use of a basic computational flow needed for Doppler compensation, basically using temporal Wiener filtering in virtual pilot sub-carriers for obtaining estimates of H′_{I} and H_{I} in these pilot sub-carriers. Then, spectral Wiener filtering is used for noise averaging and interpolation to obtain H′ⱼ and Hⱼ in all sub-carriers.

In Terrestrial Digital Video Broadcast (DVB-T), Orthogonal Frequency Division Multiplex (OFDM) is used for transmitting digital information via a frequency-selective broadcast channel.

If all objects such as the transmitter, the receiver and other scattering objects are stationary, the usage of OFDM having a guard interval of proper length containing a cyclic prefix leads to orthogonal sub-carriers, i.e., simultaneous demodulation of all sub-carriers using an FFT results in no inter-carrier interference. If objects are moving so fast that the channel cannot be regarded anymore as being stationary during an OFDM symbol time, the orthogonality between sub-carriers is lost and the received signal is corrupted by ICI, i.e., the signal used to modulate a particular sub-carrier also disturbs other sub-carriers after demodulation. In the frequency domain, such Doppler broadening of a frequency selective Rayleigh fading channel can be understood as if the frequency response H(ƒ) of the channel is evolving as a function of time, but quite independently for frequencies that are farther apart than the coherence bandwidth. It turns out that for an OFDM system using an 8k FFT the afore-mentioned ICI levels exclude the usage of 64-QAM already at low vehicle speed.

In the present invention, Wiener filtering is used for exploiting the spectral and temporal correlation that exists within and between OFDM symbols for estimation of H(ƒ) and H′(ƒ).

A linear mobile multipath propagation channel is assumed consisting of uncorrelated paths, each of which has a complex attenuation hₗ, a delay τₗ, and a uniformly distributed angle of arrival θₗ. The complex attenuation hₗ is a circular Gaussian random variable with zero mean value. The channel impulse response has an exponentially decaying power profile and is characterized by a root mean square delay spread τᵣₘₛ. It is further assumed that the receiver moves with a certain speed v resulting in each path having a Doppler shift ƒₗ=ƒ_{d} cos θₗ so that the complex attenuation of path l at time t becomes hₗ(t)=hₗ exp(j2πƒₗt). The maximum Doppler shift ƒ_{d} relates to the vehicle speed as ƒf_{d}=f_{c}(v/c) (assuming this to be the same for all sub-carriers), where
c=3·10⁸ m/s, and ƒ_{c} is the carrier frequency.

In an OFDM system, N “QAM-type” symbols (In a DVB-T system, N is 2048 or 8192), denoted as s=[s_{0,} . . . , s_{N-1}]^{T}, are modulated onto N orthogonal sub-carriers by means of an N-point IFFT to form an OFDM symbol with duration Tᵤ. The symbol is further extended with a cyclic prefix and subsequently transmitted. The transmitted signal goes through the time-varying selective fading channel. It is assumed that the cyclic prefix extension is longer than the duration of the channel impulse response so that the received signal is not affected by inter-symbol interference. At the receiver side, the received signal is sampled at rate 1/T (where T=Tᵤ/N) and the cyclic prefix is removed. Next, an N-point FFT is used to simultaneously demodulate all sub-carriers of the composite signal.

The baseband received signal in time domain is denoted as r(t) and expressed as follows:

$$\begin{matrix}r ( t ) = {\sum }_{n = 0}^{N - 1} {H}_{n} ( t ) {ⅇ}^{j2 π {nf}_{s} t} {s}_{n} + v ( t ) , \\ {H}_{n} ( t ) = {\sum }_{l} {h}_{l} ( t ) {ⅇ}^{- j2 π {nf}_{s} {τ}_{l}} ,\end{matrix} \qquad ( 1 )$$

where Hₙ(t) is the channel frequency response of sub-carrier n at time t, ƒₛ=1/Tᵤ is the sub-carrier spacing and v(t) is AWGN having a two-sided spectral density of N₀/2.

The Taylor expansion of Hₙ(t) is taken around to and approximated up to the first-order term:
Hₙ(t)=Hₙ(t₀)+H′ₙ(t₀)(t−t₀)+O((t−t₀)²) (2)

Using equations (1) and (2), after undergoing the sampling operation and the FFT, the received signal at the m-th sub-carrier, yₘ, can be approximated as follows:

$${y}_{m} \approx \frac{1}{N} {\sum }_{k = 0}^{N - 1} {\sum }_{n = 0}^{N - 1} {H}_{n} ( {t}_{0} ) {ⅇ}^{j2π {f}_{s} ( n - m ) k T} {s}_{n} + \frac{1}{N} {\sum }_{k = 0}^{N - 1} {\sum }_{n = 0}^{N - 1} {H}_{n}^{′} ( {t}_{0} ) ( k T - {t}_{0} ) {ⅇ}^{j2 π {f}_{s} ( n - m ) k T} {s}_{n} + {v}_{m} , \qquad ( 3 )$$

where vₘ is the m-th noise sample after the FFT. Substituting T=1/(Nƒₛ) and using equation(3) can be rewritten as follows:

$$\frac{1}{N} {\sum }_{k = 0}^{N - 1} {ⅇ}^{j2 π ( n - m ) k / N} = δ ( n - m ) . \\ {y}_{m} \approx {H}_{m} ( {t}_{0} ) {s}_{m} + {\sum }_{n = 0}^{N - 1} {H}_{n}^{′} ( {t}_{0} ) {Ξ}_{m , n} {s}_{n} + {n}_{m} ; \qquad ( 4 )$$

where t₀=ΔT. In matrix notation, the following approximation is used for the channel model:
y≈Hs+Ξ H′s+n, (6)
where H=diag(H₀(t₀), . . . , H_{N-1}(t₀)) and H′=diag(H′₀ (t₀), . . . , H′_{N-1}(t₀)). t₀ is chosen so that the error of the channel approximation is the smallest, i.e., in the middle of the useful part of an OFDM symbol.

The first term in equation (6) is equivalent to the distorted wanted signal in the static environment where there is no movement. The corresponding channel frequency response H has the following second order statistics in time and frequency:

$$E [ {H}_{m} ( {t}_{0} ) {H}_{n}^{*} ( {t}_{0} ) ] = \frac{1}{1 + j 2 π {τ}_{rma} ( m - n ) {f}_{s}} , \qquad ( 7 )$$

E[Hₘ(t+τ)H*ₘ(t)]=J₀(2 πƒ_{d}τ). (8)
where Jₙ is the Bessel function of the first kind of order n. The ICI described in the second term of equation (6) is the result of the spreading of the symbols transmitted at all other sub-carriers by the fixed spreading matrix Ξ weighted by the derivatives H′ₘ. Since Ξ is a fixed matrix, the channel model is fully characterized by Hₘ and H′ₘ. Knowledge of this structure is advantageous for channel estimation, as the number of parameters to be estimated is 2N rather than N².

Equation (6) also forms the basis of the ICI suppression scheme as first the ICI is approximated using estimates of H′ and s, followed by subtracting it from the received signal y.

Linear Minimum Mean Square Error (MMSE) estimates of the channel parameters (Hₘ and H′ₘ) and the transmitted data are obtained by applying discrete-time or discrete-frequency Wiener filtering. Suppose that a set of noisy observations yₖ, k ∈ {1, . . . , L} is available from which a random variable xₗ is to be estimated. A linear MMSE estimate of xₗ is obtained by using an L-tap FIR filter:

$${\hat{x}}_{l} = {\sum }_{k = 1}^{L} {α}_{k} {y}_{k} , \qquad ( 9 )$$

where minimization of the Mean Square Error requires that αk satisfy the so-called Normal
Equations:

$$E [ {x}_{l} {y}_{m}^{*} ] = {\sum }_{k = 1}^{L} {α}_{k} E [ {y}_{k} {y}_{m}^{*} ] ; m ∈ \{ 1 , … , L \} . \qquad ( 10 )$$

It can then be shown that the Mean Square Error (MSE) of the estimation using these filter coefficients equals MSE=E[|xₗ|²]−E[|x^{ˆ}ₗ|²].

The matrix H is estimated per OFDM symbol basis by using the regular structure of the scattered pilots in the OFDM symbols as defined by the DVB-T standard. The pilot symbols provide noisy initial estimates of H at the pilot positions, where the noise consists both of AWGN and the ICI caused by Doppler spread. A FIR filter is applied in the frequency and/or temporal domain for obtaining MMSE estimates of H at the pilot symbols, exploiting the spectral correlation of H. Next, these results are interpolated to obtain H at the remaining data sub-carriers in between the pilot sub-carriers.

The approach is to estimate H′ₘ using the temporal correlation of Hₘ as given in equation (8). It can be shown that the random process H′ₘ (t) exists because R_{HH}(t) is band-limited, where R_{HH}(t) stands for the temporal correlation of H at a fixed frequency. Given a set of noisy measurements y(t)=Hₘ(t)+n(t) from a number of consecutive OFDM symbols, a temporal Wiener filter can be designed that provides MMSE estimates of H′ₘ(t) using these noisy measurements, if the second order statistics E[Y(t)y*(s)] and E[H′ₘ (t)y*(S)] are known. Using the independence between noise and H and Equation (8), equation (11) is obtained:
E|y(t)y*(s)|=J₀(2πƒ_{d}(t−s)+a_{π}²ξ(t−s). (11)

Similarly, equation (12) is obtained:

$$\begin{matrix}E [ {H}_{m}^{′} ( t ) {y}^{*} ( s ) ] = E [ {H}_{m}^{′} ( t ) ( {H}_{m}^{*} ( s ) + {n}_{m}^{*} ( s ) ) ] = E [ {H}_{m}^{′} ( t ) {H}_{m}^{*} ( s ) ] \\ = E [ \{ l . i . m {.}_{ɛ \to 0} \frac{{H}_{m} ( t + ɛ ) - {H}_{m} ( t )}{ɛ} \} {H}_{m}^{*} ( s ) ] \\ = {lim}_{ɛ \to 0} \frac{E [ {H}_{m} ( t + ɛ ) {H}_{m}^{*} ( s ) ] - E [ {H}_{m} ( t ) {H}_{m}^{*} ( s ) ]}{ɛ} \\ = \frac{\partial }{\partial t} {R}_{HH} ( t , s ) = - 2 π {f}_{d} {J}_{1} ( 2 π {f}_{d} ( t - s ) ) ,\end{matrix} \qquad ( 12 )$$

where l.i.m. stands for “limit in the mean”. Using these correlation functions, Wiener filters are obtained that estimate H′ₘ (t) in the middle of an OFDM symbol using noisy estimates of Hₘ(t) from the surrounding OFDM symbols. Actually, the temporal Wiener filter may be used only for an equally spaced subset of sub-carriers called virtual pilot sub-carriers. At the remaining sub-carriers H′ₘ may be obtained by interpolation in the frequency domain exploiting the spectral correlation of H′ₘ, which turns out to be the same as that of Hₘ (Equation (7)).

Finally, R_{H′H′}(0) is needed, the power of the WSS derivative process for the performance evaluation of the Wiener filters for H′ₘ:

$$\begin{matrix}{R}_{{H}^{′} {H}^{′}} ( 0 ) = - {lim}_{τ \to 0} {( \frac{ⅆ}{ⅆ τ} )}^{2} {R}_{HH} ( τ ) \\ = - {lim}_{τ \to 0} {( \frac{ⅆ}{ⅆ τ} )}^{2} {J}_{0} ( 2 π {f}_{d} \cdot τ ) \\ = \frac{{( 2 π {f}_{d} )}^{2}}{2} .\end{matrix} \qquad ( 13 )$$

The data estimation is performed per sub-carrier using standard MMSE equalizers. If a low-complexity solution is desired, one-tap MMSE equalizers may be chosen.

Using the derivation as given above, the estimated symbol at sub-carrier m is given as follows:

$${\hat{s}}_{m} = \frac{{\hat{H}}_{m}^{*}}{{\vert {\hat{H}}_{m} \vert}^{2} + {σ}_{ICI , m}^{2} + {σ}_{\hat{H}}^{2} + {N}_{0}} {y}_{m} , \\ where \\ {σ}_{ICI , m}^{2} = {\sum }_{n = 0}^{N - 1} {\vert {Ξ}_{m , n} \vert}^{2} {\vert {H}_{n}^{′} \vert}^{2} E [ {s}_{n} {s}_{n}^{*} ] \qquad ( 14 )$$

is the ICI power at sub-carrier m and τ²_{H} is the MSE of H estimation.

Since the ratio of the signal power to the interference plus noise power (SINR) of the received signal is low in a high-speed environment due to the ICI, the estimated data might not have sufficient quality for symbol detection. However, the soft-estimated data can still be used for regenerating the ICI sufficiently accurately to be used for canceling it largely from the received signal. Because of the ICI removal operation, the SINR improves and therefore better estimated data can be obtained by performing data re-estimation. However, as the SINR increases, the MSE of Hₘ needs also to be lower, so that the inaccuracy in the estimated Hₘ does not become a dominant source of error in data re-estimation process. Therefore a re-estimation of H is also performed.

FIG. 4 shows the complete iterative channel and data estimation scheme according to the present invention. At the scattered pilot positions, the channel transfer function Hₘ is estimated from the received signal y₀ with the help of the known pilot symbols aₚ in block 11. The result H₀ is subsequently fed into first spectral H Wiener filters 12. The output H₁ is fed into first temporal/spectral H′ Wiener filters 13, to obtain the estimate of H′ₘ at sub-carriers m, Ĥ′₁.

The outputs y₀ (or y_{I}) and Ĥ₁ are fed into a first data estimator 14. The estimated data â₁ and Ĥ′₁ are subsequently used for canceling the ICI from y₀ in a similar way as Equation (15), see block 15.

Re-estimation of H and data are then performed on the reduced-ICI received signal y₁using the similar procedure of estimating H and data but with the filters and equalizers adapted to the reduced-ICI condition. Thus, a second channel estimation is performed at pilot positions in block 16 in order to obtain Ĥ₂, which is subsequently filtered in second spectral H Wiener filters 17 to obtain Ĥ₃ in all sub-carriers, which is used for a second data estimation in block 18 to obtain data â₂.

An additional operation may be performed prior to the first data estimation (see patent application filed concurrently herewith with reference ID696812, the contents of which is incorporated in the present specification by reference) in order to ensure the whiteness of the residual ICI plus noise process at the input of second H filters, namely, the removal of pilot-induced ICI from the received signal. This operation uses Ĥ′₁ and the known pilot symbols aₚ to regenerate the ICI caused by the pilot symbols on all sub-carriers and subsequently cancels it from y₀.

The performance of the DVB-T system according to the invention using the proposed iterative scheme is discussed below. The 8k mode is used in the simulations. However, in order to shorten the simulation times, around 1000 sub-carriers are used. The 64-QAM symbols modulated at the data sub-carriers are randomly generated. Scattered pilots are inserted according to the DVB-T specification. After IFFT, the signal is extended with a cyclic prefix of ratio 1/8. The carrier frequency ƒ_{c} is chosen at 600 MHz, approximately in the middle of the spectrum for analog TV in the UHF band. The channel model used is a frequency selective Rayleigh fading channel with a normalized exponentially decaying power profile with τᵣₘₛ=1 μs and maximum delay spread of 10 μs. At the receiver side, Gaussian noise with Eₛ/N₀ of 30 dB is added. For the Wiener filtering operations, symmetric non-causal filters with length L=11 and asymmetric causal filters with length L=10 are used for H and H′ filtering, respectively. All filters are optimized for each speed.

FIGS. 5, 6 and 7 show the SINR, the average MSE of H, and the Bit Error Rate (BER) for various stages of processing in the iterative scheme, from the static condition to vehicle speed of 250 km/h. Note that the average MSE is normalized to the average power of H (E[|H|²]=1). Without any processing, both the SINR and the average MSE of H decrease rapidly as the vehicle speed increases. At 200 km/h, with SINR of approximately 18 dB, it is obvious that a reliable detection for 64-QAM on a Rayleigh fading channel is impossible. The first H filtering 12 decreases the MSE approximately 6.5 dB. At this stage, the BER before ICI removal is measured. Due to the ICI removal, the SINR increases approximately 8 dB for higher speeds. It is noticed that the reduced SINR has come close to the accuracy of H. With the second H filtering 17, the MSE is brought approximately 7 dB down again. With the re-estimated H and the reduced-ICI received signal, a BER of 2·10⁻² is obtained at speed 200 km/h. For lower vehicle speeds, since the ICI is less severe, the Gaussian noise becomes more dominant. That is why the gain obtained due to ICI removal decreases.

For practical implementation, the fixed filters designed for the worst case situation (e.g. speed 200 km/h) may be used. Although for the lower speeds the performance is sub-optimum, the performance degradation is not significant.

As an example, the designing of a temporal filter for f_{d,max} of 112 Hz and T_{OFDM} (time between consecutive OFDM symbols of) 0.001 s yields:

$$[ \begin{matrix}{w}_{0} \\ {w}_{- 1} \\ {w}_{- 2} \\ {w}_{- 3} \\ {w}_{- 4} \\ {w}_{- 5} \\ {w}_{- 6} \\ {w}_{- 7} \\ {w}_{- 8} \\ {w}_{- 9}\end{matrix} ] = {10}^{3} * [ \begin{matrix}0.7457 \\ - 0.0940 \\ - 1.0751 \\ - 0.0985 \\ 0.5663 \\ 0.2850 \\ - 0.2838 \\ - 0.2922 \\ 0.2213 \\ 0.0039\end{matrix} ]$$

The spectral filter for the same conditions could be:

$$[ \begin{matrix}w [ 0 ] \\ w [ 1 ] \\ w [ 2 ] \\ w [ 3 ] \\ w [ 4 ] \\ w [ 5 ] \\ w [ 6 ] \\ w [ 7 ] \\ w [ 8 ] \\ w [ 9 ] \\ w [ 10 ]\end{matrix} ] = [ \begin{matrix}- 0.0026 - 0.0629 i \\ 0.0003 - 0.0253 i \\ 0.0151 + 0.0144 i \\ 0.0450 + 0.0493 i \\ 0.0877 + 0.0694 i \\ 0.1337 + 0.0666 i \\ 0.1682 - 0.0402 i \\ 0.1770 - 0.0000 i \\ 0.1544 - 0.0363 i \\ 0.1068 - 0.0499 i \\ 0.1012 - 0.0581 i\end{matrix} ]$$

The different filters and operations may be performed by a dedicated digital signal processor (DSP) and in software. Alternatively, all or part of the method steps may be performed in hardware or combinations of hardware and software, such as ASIC:s (Application Specific Integrated Circuit), PGA (Programmable Gate Array), etc.

It is mentioned that the expression “comprising” does not exclude other elements or steps and that “a” or “an” does not exclude a plurality of elements. Moreover, reference signs in the claims shall not be construed as limiting the scope of the claims.

Herein above has been described several embodiments of the invention with reference to the drawings. A skilled person reading this description will contemplate several other alternatives and such alternatives are intended to be within the scope of the invention. Also other combinations than those specifically mentioned herein are intended to be within the scope of the invention. The invention is only limited by the appended patent claims.

1. A method of processing OFDM encoded digital signals, wherein said OFDM encoded digital signals are transmitted as sub-carriers in several frequency channels, comprising:
estimating a channel transfer function (Ĥ₁) by a channel estimation scheme in each sub-carrier;
estimating data (â₁) by a data estimation scheme from said channel transfer function (Ĥ₁) and a received signal (y₀)
estimating a derivative (Hⱼ′) of said channel transfer function in a subset of said sub-carriers by a temporal filtering; and
removing inter-carrier interference (ICI) from said received signal by using said estimated data (â₁) and said estimated derivative (Hⱼ′) of said channel transfer function in order to obtain a cleaned received signal (yₗ)

2. The method of claim 1, wherein said temporal filtering is performed in virtual pilot channels for obtaining said derivative (H_{I}′) for said pilot channels; and further comprising spectral interpolation from said obtained derivative (H_{I}′) for computing the derivative (Hⱼ′) for remaining channels within an OFDM symbol.

3. The method of claim 2, wherein said pilot channels are a subset of all channels.

4. The method of claim 1, wherein said temporal filtering is performed by using a finite impulse transfer function (FIR) filter having pre-computed filter coefficients.

5. The method of claim 1, wherein said spectral filtering is performed by using a finite impulse transfer function (FIR) filter having pre-computed filter coefficients.

6. The method of claim 4, wherein said finite impulse transfer function filter uses estimates of said channel transfer function H from at least one other OFDM symbol.

7. The method of claim 6, wherein said other OFDM symbol is a future OFDM symbol.

8. The method of claim 1, further comprising subtracting an inter-carrier interference (ICI) computed by using an initial estimation of said derivative (H′) of said channel transfer function and an initial soft estimation of data.

9. The method of claim 8, characterized by a further estimation of said channel transfer function (H) after removal of said inter-carrier interference (ICI) in at least said virtual pilot channels, whereby a more accurate data estimation is obtained.

10. The method of claim 1, further comprising removing said inter-carrier interference (ICI) by an iteration of data estimation steps and removal steps.

11. A signal processor arranged to process OFDM encoded digital signals, for counteracting inter-carrier interference (ICI) caused by Doppler broadening, wherein said OFDM encoded digital signals are transmitted as sub-carriers in several channels which form OFDM blocks, comprising:
a channel estimator arranged to estimate a channel transfer function (Ĥ₁) by a channel estimation scheme in each sub-carrier;
a data estimator arranged to estimate data (âₗ) by a data estimation scheme from said channel transfer function (Ĥ₁) and a received signal (y₀);
a derivative estimator arranged to estimate a derivative (Hⱼ′) of said channel transfer function in each sub-carrier by a temporal filtering; and
an inter-carrier interference remover arranged to remove inter-carrier interference (ICI) from said signal by using said estimated data (â₁) and said estimated derivative (Hⱼ′) of said channel transfer function in order to obtain a cleaned signal (yₗ)

12. The use of temporal Wiener filtering for channel estimation followed by spectral Wiener filtering according to the method of claim 1 for counteracting inter-carrier interference (ICI).

13. A receiver arranged to receive OFDM encoded digital signals which are transmitted as sub-carriers in several channels which form OFDM blocks, comprising:
a channel estimator arranged to estimate a channel transfer function (Ĥ₁) by a channel estimation scheme in each sub-carrier;
a data estimator arranged to estimate data (âₗ) by a data estimation scheme from said channel transfer function (Ĥ₁) and a received signal (y₀);
a derivative estimator arranged to estimate a derivative (Hⱼ′) of said channel transfer function in each sub-carrier by a temporal filtering; and
an inter-carrier interference remover arranged to remove inter-carrier interference (ICI) from said signal by using said estimated data (âₗ) and said estimated derivative (Hⱼ′) of said channel transfer function in order to obtain a cleaned signal (y₁).

14. A mobile device comprising a receiver according to claim 13.

15. A mobile device arranged to carry out the method according to claim 1.

16. A telecommunication system comprising a mobile device according to claim 13.
